(19) United States
(12) Patent Application Publication
(10) Pub. No.: US 2012/0276325 A1
(43) Pub. Date: Nov. 1, 2012

(54) ALUMINA TITANATE POROUS STRUCTURE

(75) Inventors: Stephane Raffy, Cavaillon (FR); Nabil Nahas, Serris (FR)

(73) Assignee: SAINT-GOBAIN CENTRE DE RECHERCHES ET D'ETUDES EUROPEEN, Courbevoie (FR)

(21) Appl. No.: 13/497,567

(22) PCT Filed: Sep. 21, 2010
(86) PCT No.: PCT/FR2010/051971

§ 371 Date: Mar. 22, 2012

(30) Foreign Application Priority Data
Sep. 22, 2009 (FR) 09 56502
Jul. 27, 2010 (FR) 10 56155

(51) Int. Cl. C04B 35/10; B32B 3/12

(52) U.S. Cl. 428/116; 501/104; 501/105

(57) ABSTRACT

Porous structure comprising an oxide ceramic material comprising, on the basis of the corresponding simple oxides: Al₂O₃, TiO₂, at least one oxide of an element M₂ chosen from the group formed by Fe₂O₃, Cr₂O₃, MnO₂, La₂O₃, Y₂O₃ and Ga₂O₃, at least one oxide of an element M₃ chosen from the group formed by ZrO₂, Ce₂O₃ and HfO₂, optionally at least one oxide of an element M₁ chosen from MgO and CoO, and optionally SiO₂, said material being obtained by the reactive sintering of the corresponding simple oxides or of their precursors or by heat treatment of the sintered particles satisfying said composition.

The invention relates to a porous structure such as a catalyst support or a particulate filter, the material constituting the filtering and/or active portion of which is based on aluminum titanate. The ceramic material forming the basis of the ceramic filters or supports according to the present invention are predominantly formed from oxides of the elements Al, Ti. The porous structures usually have a honeycomb structure and are used especially in an exhaust line of a diesel-type internal combustion engine.

In the rest of the description, said oxides comprising the elements will be described, for convenience and in accordance with the practice in the field of ceramics, by reference to the corresponding simple oxides, for example Al₂O₃ or TiO₂. In particular, in the following description, unless mentioned otherwise, the proportions of the various elements constituting the oxides according to the invention are given by reference to the weight of the corresponding simple oxides, as percentages by weight relative to the sum of the oxides present in the chemical compositions described.

In the remainder of the description, the application and the advantages in the specific field of filters or catalyst supports for removing the pollutants contained in the exhaust gases coming from a gasoline or diesel internal combustion engine, to which field the invention relates, will be described. At the present time, structures for decontaminating exhaust gases all have in general a honeycomb structure.

As is known, during its use, a particulate filter is subjected to a succession of filtration (soot accumulation) and regeneration (soot removal) phases. During filtration phases, the soot particles emitted by the engine are retained and deposited inside the filter. During regeneration phases, the soot particles are burnt off inside the filter, so as to restore the filtration properties thereof. It will therefore be understood that the mechanical strength properties both at low and high temperature of the material constituting the filter are of paramount importance for such an application. Likewise, the material must have a structure which is sufficiently stable to withstand, especially over the entire lifetime of the vehicle fitted therewith, temperatures which may rise locally up to well above 1000° C., especially if some regeneration phases are poorly controlled.

At the present time, filters are mainly made of a porous ceramic material, especially silicon carbide or cordierite. Silicon carbide catalytic filters of this type are for example described in patent applications EP 816 065, EP 1 142 619, EP 1 455 923 or WO 2004/090294 and WO 2004/065088. Such filters make it possible to obtain chemically inert filtering structures of excellent thermal conductivity and having porosity characteristics, particularly average pore size and pore size distribution, which are ideal for the application of filtering soot output by a thermal engine.

However, some drawbacks specific to this material still remain: a first drawback is due to the somewhat high thermal expansion coefficient of SiC, greater than 3×10⁻⁶ K⁻¹, which does not permit large monolithic filters to be manufactured and very often requires the filter to be segmented into several honeycomb elements bonded together using a cement, such as that described in patent application EP 1 455 923. A second drawback, of economic nature, is due to the extremely high firing temperature, typically above 2100° C. for sintering, ensuring a sufficient thermomechanical strength of the honeycomb structures, especially during the successive regeneration phases of the filter. Such temperatures require the installation of special equipment, appreciably increasing the cost of the filter finally obtained.

From another standpoint, although cordierite filters have been known and used for a long time, owing to their low cost, it is known at the present time that problems may arise in such structures, especially during poorly controlled regeneration cycles during which the filter may be locally subjected to temperatures above the melting point of cordierite. The consequences of these hot spots may range from a partial loss of efficiency of the filter to its complete destruction in the severest cases. Furthermore, the chemical inertness of cordierite is insufficient at the temperatures reached during the successive regeneration cycles and consequently it is liable to react with and be corroded by the substances originating from the lubricant, fuel, oil and other residues that have accumulated in the structure during the filtration phases, which phenomenon may also be the cause of the rapid deterioration in the properties of the structure.

For example, such drawbacks have been described in the patent application WO 2004/011124 which proposes, to remedy them, a filter based on aluminum titanate (60 to wt %) reinforced with mullite (10 to 40 wt %), the durability of which is improved.

According to another embodiment, patent application EP 1 559 696 proposes the use of powders for the manufacture of honeycomb filters obtained by reactive sintering of aluminum, titanium and magnesium oxides between 1000 and 1700° C. The material obtained after sintering takes the form of a blend of two phases: a predominant phase of the pseudobrookite structural type Al₂TiO₅ containing titanium, aluminum and magnesium, and a minor feldspar phase of the Na_{y}K_{1-y}AlSi₃O₈ type.

However, the experiments conducted by the Applicant have shown that it is difficult at the present time to guarantee the performance of such a structure based on a porous material of the aluminum titanate type, in particular to achieve thermal stability, thermal expansion coefficient suitable for example for rendering them able to be directly used in a high-temperature application of the particulate filter type.

The object of the present invention is thus to provide a porous structure comprising an oxide material, having properties, as described above, which are substantially improved, especially so as to make it more advantageous to use them for the manufacture of a filtering and/or catalytic porous structure, typically a honeycomb structure.

More precisely, the present invention relates to a porous structure comprising a ceramic material, the chemical composition of which comprises, in wt % on the basis of the oxides:
more than 25% but less than 52% Al₂O₃;
more than 26% but less than 55% TiO₂;
less than 20%, in total, of at least one oxide of an element M₁ chosen from MgO and COO;
more than 1% but less than 20%, in total, of at least one oxide of an element M₂ chosen from the group formed by Fe₂O₃, Cr₂O₃, MnO₂, La₂O₃, Y₂O₃ and Ga₂O₃;
more than 1% but less than 25%, in total, or even less than 20% in total, of at least one oxide of an element M₃ chosen from the group formed by ZrO₂,
Ce₂O₃ and HfO₂;
less than 20% SiO₂; said composition having:
less than 10% MgO;
more than 1% but less than 20% Fe₂O₃;
more than 1% but less than 10% ZrO₂, said material being obtained by the reactive sintering of the corresponding simple oxides or of one of their precursors, or by heat treatment of sintered particles satisfying said composition.

As already described above, the proportions of the various elements constituting the oxides of the material are given, in the above formulation, by reference to the weight of the corresponding simple oxides, in wt % relative to the sum of the oxides present in said chemical compositions. However, it is obvious that in the context of the present invention, although the elements M₁, M₂ and M₃ are expressed in the above relationship in the form of corresponding simple oxides, this being conventional in solid-state chemistry, they are usually present, at least for a major portion, in another, more complex form in the material according to the invention and may especially be included in mixed oxides and in particular in phases of the aluminum titanate type.

Preferably, the porous structure is formed by said ceramic material.

Said porous structure according to the invention furthermore satisfies a composition, in mol % on the basis of the sum of the oxides present in said composition, such that: a′−t+2m₁+m₂ is between −6 and 6, in which:
a is the content of Al₂O₃ in mol %;
s is the content of SiO₂ in mol %;
a′=a−0.37s;
t is the content of TiO₂ in mol %;
m₁ is the total content of the oxide(s) of M₁ in mol %; and
m₂ is the total content of the oxide(s) of M₂ in mol %.

Preferably, Al₂O₃ represents more than 30% of the chemical composition. Preferably, Al₂O₃ represents less than 51% or less than 50% of the chemical composition, the percentage contents being given by weight on the basis of the oxides.

Preferably, TiO₂ less than 50%, or less than 45% of the chemical composition, the percentage content being given by weight on the basis of the oxides.

Preferably, if present the oxide(s) of M₁ represents (represent) more than 1.5% and very preferably more than 2% of the chemical composition. Preferably, the oxide(s) of M₁ represents (represent) less than 6% of the chemical composition, the percentages being given by weight and on the basis of the oxides.

Preferably, M₁ is just Mg.

Preferably, the oxide(s) of M₂ represents (represent) more than 1.5% and very preferably more than 2% and even more than 3% of the chemical composition. Preferably, the oxide(s) of M₂ represents (represent) in total less than 20% and very preferably less than 15% of the chemical composition, the percentages being given by weight and on the basis of the oxides.

Preferably, M₂ is just Fe. Also preferably, as a variant, the element M₂ may be formed by a combination of iron and lanthanum, provided that the Fe₂O₃ content remains greater than 1.0%, or even greater than 1.5%.

In such an embodiment, Fe₂O₃ (or the sum of the weight contents of the species Fe₂O₃ and La₂O₃) represents more than 1% and very preferably more than 1.5% of the chemical composition. Preferably, Fe₂O₃ (or the sum of the weight contents of Fe₂O₃+La₂O₃) represents less than 20% and very preferably less than 18%, or even less than 15% of the chemical composition, the percentages being given by weight on the basis of the oxides.

In one embodiment, the composition comprises iron and magnesium and optionally lanthanum. The corresponding oxides Fe₂O₃ and MgO and optionally La₂O₃ then represent, by weight and in total, more than 1%, even more than 1.5% and very preferably more than 2% of the chemical composition of the chemical composition. Preferably, Fe₂O₃ and MgO and optionally La₂O₃ together represent less than 18% and very preferably less than 15% of the chemical composition, the percentages being by weight on the basis of the oxides.

The oxide(s) of M₃ represents (represent) in total more than 1% of the chemical composition, the percentages being given by weight and on the basis of the oxides. Preferably, the oxide(s) of M₃ represents (represent) in total less than 10% and very preferably less than 8% of the chemical composition.

Preferably, M₃ is just Zr. Also preferably, as a variant, the element M₃ may be formed by a combination of zirconium and cerium.

In the compositions of the particles given above, according to this other preferred embodiment of the invention, the ZrO₂ (M₃ is Zr) may thus be replaced with a combination of ZrO₂ and CeO₂ (M₃ then being a combination of Zr and Ce), provided that the ZrO₂ content remains greater than 1%. For example, in such a case said material comprises more than 1% but less than 10% by weight of (ZrO₂+CeO₂), (ZrO₂+CeO₂) being the sum by weight of the contents of the two oxides in said composition.

Of course in the context of the present description, it is possible for the composition nevertheless to comprise other compounds in the form of inevitable impurities. In particular, even when only one reactant containing zirconium is initially introduced in the process for manufacturing a structure according to the invention, it is known that said reactants usually comprise a small amount of hafnium, in the form of an inevitable impurity, which may sometimes be up to 1 or 2 mol % of the total amount of zirconium introduced.

For example, the material may have the following chemical composition, in wt % on the basis of the oxides: more than 35% but less than 50% Al₂O₃, more than 26% but less than 50% TiO₂, less than 6% MgO, more than 2% but less than 15% Fe₂O₃, more than 2% but less than 8% ZrO₂ and more than 0.5% but less than 15% SiO₂.

In addition to the contents by weight of all of the oxides present, the structures according to the invention may also contain other minor elements. In particular, the structures may contain silicon in an amount between 0.1 and 20% by weight on the basis of the corresponding oxide SiO₂. For example, SiO₂ represents more than 0.1%, especially more than 0.5% or even more than 1% or else more than 2%, indeed more than 3% or even more than 5% of the chemical composition. For example, SiO₂ represents less than 18%, especially less than 15%, or even less than 12% or else less than 10% of the chemical composition, the percentages being given by weight on the basis of the oxides.

The porous structure may also contain other elements such as boron, alkali metals or alkaline-earth metals of the type Ca, Sr, Na, K, Ba, the total summed amount of said elements present preferably being less than 10% by weight, for example less than 5%, or 4%, or 3% by weight on the basis of the corresponding oxides B₂O₃, CaO, SrO, Na₂O, K₂O, BaO, in addition to the contents by weight of all the oxides corresponding to the elements present in said porous structure. The percentage content of each minor element, on the basis of the weight of the corresponding oxide, is for example less than 4%, or 3%, or even 1%.

According to one possible embodiment of the invention, the porous structure according to the invention has the following chemical composition, in wt % on the basis of the oxides:
more than 25% but less than 52% Al₂O₃;
more than 26% but less than 55% TiO₂;
more than 1% but less than 20% Fe₂O₃;
less than 20% SiO₂;
less than 10% MgO or even less than 2% MgO;
more than 1% but less than 10% ZrO₂; and
optionally more than 2% but less than 13%, in total, of at least one oxide chosen from the group formed by B₂O₃, CaO, Na₂O, K₂O, SrO, and BaO.

In the above chemical composition, the Fe₂O₃ may be replaced, in the same proportions, with a combination of Fe₂O₃ and La₂O₃.

Likewise, according to another embodiment that may be combined with the previous one, in the above chemical composition the ZrO₂ may be replaced, in the same proportions, with a combination of ZrO₂ and CeO₂.

According to another possible embodiment of the invention, the porous structure according to the invention has the following chemical composition, in wt % on the basis of the oxides:
more than 35% but less than 51% Al₂O₃, for example between 38 and 50% Al₂O₃;
more than 26% but less than 45% TiO₂;
more than 1% but less than 20% Fe₂O₃ or a combination (Fe₂O₃+La₂O₃);
optionally more than 0.1% but less than 20% SiO₂;
less than 2% MgO or even less than 1% MgO;
more than 1% but less than 10% ZrO₂; and
optionally more than 2% but less than 13%, in total, of at least one oxide chosen from the group formed by B₂O₃, CaO, Na₂O, K₂O, SrO and BaO.

In the above chemical composition, the Fe₂O₃ may be replaced, in the same proportions, with a combination of Fe₂O₃ and La₂O₃.

Likewise, according to another embodiment that may be combined with the previous one, in the above chemical composition the ZrO₂ may be replaced, in the same proportions, with a combination of ZrO₂ and CeO₂.

Such a chemical composition preferably has, in wt % on the basis of the oxides:
between 1 and 18% Fe₂O₃ or (Fe₂O₃+La₂O₃)
between 3 and 18% SiO₂; and
between 1 and 8% ZrO₂ or (ZrO₂+CO₂).

So as not to unnecessarily burden the present description, all possible combinations according to the invention between the various preferred embodiments of the compositions of materials according to the invention, as described above, will not be reported. However, of course all possible combinations of the initial and/or preferred values and fields described above may be envisioned and must be considered as described by the Applicant within the context of the present description (especially two, three or more combinations).

The porous structure according to the invention may furthermore comprise mainly or be formed by an oxide phase of the solid-solution type comprising titanium, aluminum, at least one element chosen from M₂, at least one element chosen from M₃ and optionally an element chosen from M₁ and at least one phase essentially consisting of titanium oxide TiO₂ and/or zirconium oxide ZrO₂ and/or cerium oxide CeO₂ and/or hafnium oxide HfO₂ and optionally at least one silicate phase.

Preferably, the porous structure according to invention may mainly comprise or be formed by an oxide phase of the solid-solution type comprising titanium, aluminum, iron, zirconium and optionally magnesium and at least one phase essentially consisting of titanium oxide TiO₂ and/or zirconium oxide ZrO₂ and optionally at least one silicate phase.

Said silicate phase may be present in proportions that may range from 0 to 45% of the total weight of the material. Typically, said silicate phase consists mainly of silica and alumina, the proportion by weight of silica in the silicate phase being greater than 34%.

According to possible alternative embodiments:
Al₂O₃ may represent between 48 and 54 wt %;
TiO₂ may represent between 35 and 48 wt %, for example between 38 and 45 wt %;
Fe₂O₃ or (Fe₂O₃+La₂O₃) may represent between 1 and 8 wt %, for example between 2 and 6 wt %;
SiO₂ is present in proportions of less than 1 wt %, or even less than 0.5 wt %;
ZrO₂ (or ZrO₂+CeO₂) is less than 3 wt %; and
MgO may represent between 1 and 8 wt %, for example between 2 and 6 wt %.

The material constituting the porous structure according to the invention may be obtained by any technique normally used in the field.

According to a first variant, the material constituting the structure may be obtained directly, in the conventional manner, by simply mixing the initial reactants in the appropriate proportions for obtaining the desired composition, followed by heating and reaction in the solid state (reactive sintering).

Said reactants may be the simple oxides Al₂O₃, TiO₂, for example, and optionally other oxides of elements liable to be in the structure, for example in the form of a solid solution. It is also possible according to the invention to use any precursor of said oxides, for example in the form of carbonates, hydroxides or other organometallics of the above elements. The term “precursor” is understood to mean a material which decomposes into a simple oxide corresponding to a stage often prior to the heat treatment, i.e. at a heating temperature typically below 1000° C., or below 800° C. or even below 500° C.

According to another method of manufacturing the structure according to the invention, said reactants are sintered particles which correspond to the above-mentioned chemical composition and are obtained from said simple oxides. The blend of the initial reactants is presintered, i.e. it is heated to a temperature allowing the simple oxides to react so as to form sintered particles comprising at least one main phase of structure of the aluminum titanate type. It is also possible according to this embodiment to use precursors of said aforementioned oxides. Again, as above, the blend of precursors is sintered, that is to say it is heated to a temperature allowing the precursors to react so as to form sintered particles comprising predominantly at least one phase having a structure of the aluminum titanate type.

One process for manufacturing such a structure according to the invention is in general the following: Firstly, the initial reactants are blended in the appropriate proportions for obtaining the desired composition.

In a manner well known in the field, the manufacturing process typically includes a step of mixing the initial blend of reactants with an organic binder of the methyl cellulose type and a pore former for example such as: starch, graphite, polyethylene, PMMA, etc. and the progressive addition of water until the plasticity needed to allow the step of extruding the honeycomb structure is obtained.

For example, during the first step, the initial blend is mixed with 1 to 30 wt % of at least one pore-forming agent chosen according to the desired pore size, and then at least one organic plasticizer and/or an organic binder and water are added.

The mixing results in a homogeneous product in the form of a paste. The step of extruding this product through a die of suitable shape makes it possible, using well-known techniques, to obtain honeycomb-shaped monoliths. The process may for example then include a step of drying the monoliths obtained. During the drying step, the green ceramic monoliths obtained are typically dried by microwave drying or by thermal drying, for a time sufficient to bring the non-chemically-bound water content to less than 1 wt-%. When it is desired to obtain a particulate filter, the process may further include a step of blocking every other channel at each end of the monolith.

The step of firing the monoliths, the filtering portion of which is based on aluminum titanate, is in principle carried out at a temperature above 1300° C. but not exceeding 1800° C., preferably not exceeding 1750° C. The temperature is adjusted in particular according to the other phases and/or oxides that are present in the porous material. Usually, during the firing step, the monolith structure is heated to a temperature of between 1300° C. and 1600° C. in an atmosphere containing oxygen or an inert gas.

Although one of the advantages of the invention lies in the possibility of obtaining monolithic structures of greatly increased size without the need for segmentation, unlike SiC filters (as described above), according to one embodiment which is not, however, preferred, the process may optionally include a step of assembling the monoliths into a filtration structure assembled using well-known techniques, for example those described in patent application EP 816 065.

The filtering structure or structure made of porous ceramic material according to the invention is preferably of the honeycomb type. It has a suitable porosity, greater than 10%, generally between 20 and 70%, or between 30 and 60%, the average pore size being ideally between 5 and 60 microns, in particular between 10 and 20 microns, as measured by mercury porosimetry on a Micromeritics 9500 apparatus.

Such filtering structures typically have a central portion comprising a number of adjacent ducts or channels of mutually parallel axes that are separated by walls formed by the porous material.

In a particulate filter, the ducts are closed off by plugs at one or other of their ends so as to define inlet chambers opening onto a gas entry face and outlet chambers opening onto a gas discharge face, in such a way that the gas passes through the porous walls.

The present invention also relates to a filter or to a catalyst support obtained from a structure as defined above and by depositing, preferably by impregnation, at least one active catalytic phase, which is supported or preferably not supported, typically comprising at least one precious metal, such as Pt and/or Rh and/or Pd and optionally an oxide such as CeO₂, ZrO₂ or CeO₂—ZrO₂. The catalyst supports also have a honeycomb structure, but the ducts are not closed off by plugs and the catalyst is deposited in the pores of the channels.

The invention and its advantages will be better understood on reading the following non-limiting examples. In the examples, unless otherwise mentioned, all the percentage content are given by weight.

### EXAMPLES

In the examples, the specimens were prepared from the following raw materials:
Almatis CL4400FG alumina comprising 99.8% Al₂O₃ and having a median diameter d₅₀ of about 5.2 μm;
TRONOX T-R titanium oxide comprising 99.5% TiO₂ and having a diameter of around 0.3 μm;
SiO₂ Elkem Microsilicia Grade 971U having a purity of 99.7%;
Fe₂O₃ having a purity of greater than 98%;
lime comprising about 97% CaO, with more than 80% of the particles having a diameter of less than 80 μm;
strontium carbonate comprising more than 98.5% SrCO₃, sold by Societe des Produits Chimiques Harbonnières;
zirconium having a purity of greater than 98.5% and a median diameter d₅₀ of 3.5 μm, sold under the reference CC10 by the company Saint-Gobain ZirPro;
lanthanum oxide La₂O₃ having a purity of greater than 99%; and
cerium oxide comprising about 99% CeO₂, having particles having a mean diameter of less than 20 μm.

The specimens according to the invention and the comparative specimens were obtained from the above reactants, blended in the appropriate proportions.

More precisely, the blends of the initial reactants were blended then pressed in the form of cylinders which are then sintered at the temperature indicated in Table 1 for 4 hours in air.

The prepared specimens were then analyzed. The results of the analyses carried out on each of the specimens of the examples are given in Table 1.

In Table 1:
1) the chemical composition, indicated in wt % on the basis of the oxides, was determined by X-ray fluorescence;
2) the crystalline phases present in the refractory products were characterized by X-ray diffraction and microprobe analysis EPMA (Electron Probe Micro Analyser). On the basis of the results thus obtained, the weight percentage of each phase and its composition were able to be estimated. In Table 1, AT indicates a solid solution of oxides (main phase) of the aluminum titanate type, PS indicates the presence of a silicate phase, other phase(s) indicate(s) the presence of at least one other minor phase P2 and “˜” means that the phase is present in trace form;
3) the stability of the crystalline phases present was determined by a test consisting in comparing, by X-ray diffraction, the crystalline phases present initially with those present after a heat treatment at 1100° C. for 100 hours. The product was considered to be stable if the maximum intensity of the main peak corresponding to the appearance of corundum Al₂O₃ after this treatment remained 50% below the average of the maximum intensities of the three main peaks of the AT phase and very stable if it remained 30% below (such products are marked “yes” in Table 1).
4) The compressive strength (R) was measured at room temperature, on a LLOYD machine equipped with a 10 kN load cell, by compressing the prepared specimens at a rate of 1 mm/min; and
5) the density was measured by conventional techniques (Archimedes method). The porosity given in table 1 corresponds to the difference, given as a percentage, between the theoretical density (the expected maximum density of the material in the absence of any porosity and measured by helium picnometry on the ground product) and the measured density.

TABLE 1

| | | Example | | | | |
|---|---|---|---|---|---|---|
| | | 1 | 2 | 3 | Comp. 1 | Comp. 2 |
| Al₂O₃ | | 38.67 | 39.5 | 49.0 | 40.7 | 54.6 |
| TiO₂ | | 37.23 | 30.7 | 39.0 | 39.19 | 33.4 |
| Fe₂O₃ | | 12.07 | 10.7 | 2.0 | 12.7 | 5.34 |
| SiO₂ | | 3.84 | 10.3 | 6.0 | 4.04 | 3.12 |
| SrO | | 2.27 | 5.73 | | 2.39 | |
| CaO | | 0.36 | 0.93 | | 0.38 | 0.04 |
| MgO | | | | | | 1.37 |
| Na₂O | | 0.08 | 0.05 | | 0.08 | 0.07 |
| K₂O | | | | | | |
| ZrO₂ | | 5.48 | 1.87 | 3.0 | 0.52 | 2.04 |
| CeO₂ | | | | 1.0 | | |
| La₂O₃ | | | 0.13 | | | |
| a | | 36.6 | 35.3 | 43.2 | 38.1 | 49.1 |
| a′ | | 34.3 | 29.5 | 39.9 | 35.7 | 47.3 |
| t | | 44.9 | 35.0 | 43.9 | 46.8 | 38.3 |
| m₁ | | 0 | 0 | 0 | 0 | 3.1 |
| m₂ | | 7.3 | 6.1 | 1.1 | 7.6 | 3.1 |
| a′ − t + 2m₁ + m₂ | | −3.3 | 0.6 | −2.9 | −3.5 | 18.3 |
| Phases | AT | yes | yes | yes | yes | yes |
| | PS | yes | yes | yes | yes | yes |
| | P2 | yes | yes | yes | ~ | yes |

| | | | | | |
|---|---|---|---|---|---|
| 100-hour stability | yes | yes | yes | yes | no |
| | | | | | (42%) |
| 4-hour sintering | 1450 | 1450 | 1450 | 1450 | 1450 |
| temperature (° C.) | | | | | |
| Density | 2.79 | 3.23 | 3.13 | 2.70 | |
| Porosity | 27.6 | 11.9 | 9.8 | 28.5 | |
| R (MPa) | 60.0 | 191.6 | 195.5 | 52.6 | |

From the data of Table 1, it may be seen that there is an improvement in the combined porosity and mechanical strength characteristics: for the same sintering temperature, the table shows that the porosity of the example according to the invention is comparable to that of the comparative example. At the same time, as indicated in Table 1, the example according to the invention has a significantly higher strength R than that of the comparative example.

Thus, the products of the invention make it possible, depending on the requirement:
either to obtain better properties associated with a desired composition of the material at a set sintering (firing) temperature;
or else to adjust a high porosity level of the material (in particular by the addition of a pore former to the initial reactants) while maintaining good mechanical integrity.

1. A porous structure comprising an oxide ceramic material comprising oxides in a composition, in wt % based on a total amount of oxides of:
more than 25% but less than 52% Al₂O₃;
more than 26% but less than 55% TiO₂;
less than 20%, in total, of at least one oxide of an element M₁ selected from MgO and CoO;
more than 1% but less than 20%, in total, of at least one oxide of an element M₂ selected from the group consisting of Fe₂O₃, Cr₂O₃, MnO₂, La₂O₃, Y₂O₃ and Ga₂O₃;
more than 1% but less than 25%, in total, of at least one oxide of an element M₃ selected from the group consisting of ZrO₂, Ce₂O₃ and HfO₂;
less than 20% SiO₂;
less than 10% MgO;
more than 1% but less than 20% Fe₂O₃; and
more than 1% but less than 10% ZrO₂;
wherein the material is obtained by a reactive sintering of the oxides or of an oxide precursor, or by heat treatment of sintered particles, and wherein the composition is such that: a′−t+2 m₁+m₂ is between −6 and 6, in mol % based on the total amount of oxides, in which:
a is a content of Al₂O₃ in mol %;
s is a content of SiO₂ in mol %;
a′=a−0.37s;
t is a content of TiO₂ in mol %;
m₁ is a total content of the at least one oxide of M₁ in mol %; and
m₂ is a total content of the at least one oxide of M₂ in mol %.

2. The porous structure of claim 1, wherein M₃ is Zr or a combination of Zr and Ce, and the material comprises more than 0.7% of ZrO₂.

3. The porous structure of claim 1, wherein M₁ is Mg, M₂ comprises Fe, and M₃ comprises Zr.

4. The porous structure of claim 1, wherein M₂ is a combination of iron and lanthanum.

5. The porous structure of claim 1, wherein M₃ is a combination of zirconium and cerium.

6. The porous structure of claim 1, wherein the material comprises:
more than 25% but less than 52% Al₂O₃;
more than 26% but less than 55% TiO₂;
less than 10% MgO;
more than 1% but less than 20% of (i) Fe₂O₃ or (ii) a sum of Fe₂O₃ and La₂O₂;
more than 1% but less than 10% of (i) ZrO₂ or (ii) a sum of ZrO₂ and CeO₂, and
less than 20% SiO₂.

7. The porous structure of claim 1, wherein the material comprises:
more than 35% but less than 50% Al₂O₃;
more than 26% but less than 50% TiO₂;
less than 6% MgO;
more than 2% but less than 15% of (i) Fe₂O₃ or (ii) a sum of Fe₂O₃ and La₂O₃;
more than 2% but less than 8% of (i) ZrO₂ or (ZrO₂+CeO₂) (ii) a sum of ZrO₂ and CeO₂; and
more than 0.5% but less than 15% SiO₂.

8. The porous structure of claim 1, comprising more than 1% SiO₂.

9. The porous structure of claim 1, wherein the material comprises a main phase of a solid solution type comprising titanium, aluminum, iron, zirconium and optionally magnesium, at least one phase comprising at least one oxide selected from the group consisting of TiO₂ and ZrO₂, and optionally at least one silicate phase.

10. The porous structure of claim 9, wherein the material comprises 0 to 45% of the at least one silicate phase, based on a total weight of the material.

11. The porous structure of claim 10, in which the at least one silicate phase consists comprises mainly silica and alumina, a proportion by weight of silica in the at least one silicate phase being greater than 34%.

12. The porous structure of claim 1, having a honeycomb type structure, wherein the ceramic material has a porosity of greater than 10% and a pore size centered between 5 and 60 microns.

13. The porous structure of claim 1, comprising more than 3% SiO₂.

14. The porous structure of claim 1, comprising more than 5% SiO₂.

15. The porous structure of claim 1, wherein the material comprises
more than 1.5%, but less than 20%, in total, of at least one oxide of an element M₁ selected from MgO and CoO; and
more than 0.5%, but less than 15% SiO₂.

16. The porous structure of claim 7, wherein the material comprises more than 1.5%, but less than 6% MgO.

17. The porous structure of claim 7, wherein the material comprises more than 2%, but less than 6% MgO.

18. The porous structure of claim 1, wherein the material further comprises more than 2% but less than 13%, in total, of at least one oxide selected from the group consisting of B₂O₃, CaO, Na₂O, K₂O, SrO, and BaO.

19. The porous structure of claim 12, having a honeycomb type structure, wherein the ceramic material has a porosity of 30% to 60%.

20. The porous structure of claim 12, having a honeycomb type structure, wherein the ceramic material has a pore size centered between 10 and 20 microns.
